(19) United States
(12) Patent Application Publication
(10) Pub. No.: US 2020/0207038 A1
(43) Pub. Date: Jul. 2, 2020

(54) MULTI-MATERIAL COMPOSITE AND METHOD FOR PRODUCING SAME

(71) Applicant: TECHNISCHE UNIVERSITÄT DRESDEN, Dresden (DE)

(72) Inventors: Angelos FILIPPATOS, Dresden (DE); Daniel Sebastian WOLZ, Dresden (DE); Hubert JÄGER, Dresden (DE); Ilja KOCH, Cottbus (DE)

(73) Assignee: TECHNISCHE UNIVERSITÄT DRESDEN, Dresden (DE)

(21) Appl. No.: 16/622,659

(22) PCT Filed: Aug. 17, 2018
(86) PCT No.: PCT/EP2018/072334

§ 371 Date: Dec. 13, 2019

(30) Foreign Application Priority Data
Aug. 17, 2017 (DE) 10 2017 214 334.7

(51) Int. Cl. B29C 70/88; B32B 15/08; B29C 70/02; B29C 70/60; B32B 5/14

(52) U.S. Cl. CPC B29C 70/885; B32B 15/08; B29C 70/025; B32B 2264/10; B29C 70/606; B32B 5/145; B29C 70/603

(57) ABSTRACT

The invention relates to a method for producing a multi-material composite and to a multi-material composite.

Due to the stepwise change of material properties at the interface between different materials, in particular metallic and polymeric materials, cracks often develop in multi-material composites, whereby the service life being shortened.

The method according to the invention is based on a gradual adaptation of the material properties of the materials of a multi-material composite at the interface. A composite is formed from at least one metal layer, at least one fibre-reinforced or unreinforced first polymer layer and at least one fibre-reinforced or unreinforced second polymer layer formed from the polymer of the first polymer layer and nanoparticles, said second polymer layer being at least partially disposed between the metal layer and the first polymer layer, under the influence of elevated temperature or elevated temperature and elevated pressure, wherein nanoparticles of the second polymer layer diffuse into the first polymer layer so that a gradient layer is formed in which the nanoparticle concentration decreases in the direction of the first polymer layer.

The multi-material composite produced by the method according to the invention has a particularly long service life and can be used, for example, in drive shafts for the aviation, automotive, or shipping industry.

The invention relates to a method for producing a multi-material composite, comprising a metal layer and a fibre-reinforced or unreinforced first polymer layer, and an associated multi-material composite.

Mixed multi-material composites that have interfaces between metals and plastics, for example in the form of fibre-plastic composite components having metallic load introduction elements, are used in a variety of applications, particularly where high impact strength and hardness and high ductility is required in addition to reduced moving weight and improved strength or stiffness properties. To pick out only one example, drive shafts for the aviation, automotive, or shipping industry can be mentioned.

A challenge for the use of multi-material composites as lightweight structures consists in the connection of the metallic elements to the plastic elements so as to transmit power. The connection can be made by way of bonding by gluing, for example. Without the use of adhesives, the materials can be joined by means of pressing, infiltration and/or injection moulding, for example. In methods such as those described in DE 10 2016 202 012 B3 for thermosetting plastics and in DE 10 2014 004 158 A1 for thermoplastics, a positive connection of an FKV element to the metallic load introduction element takes place without the use of adhesives.

The immiscible materials of the multi-material composites have different material properties, e.g. fracture toughness, hardness and strength. In particular, in connecting or joining methods for producing the multi-material composite in which no adhesive is used, cracks can form and propagate in the softer of the materials due to the sudden change in the strength or the cracking/fracture toughness at the interface between the materials in the transfer of stress loads. This can lead to failure of the multi-material composite.

It is known, for example from Ma, P.-C., et al.: “Dispersion and functionalization of carbon nanotubes for polymer-based nanocomposites: A review”, Compos. Part. A: Appl. Sci. Manuf., 41 (2010), pp. 1345-1367, that modification of polymeric materials with nanoparticles can increase their fracture toughness, strength and rigidity, the degree of increase depending inter alia on the concentration of nanoparticles in the material. Particularly favourable material properties can be achieved by modifying the polymeric materials with carbon-based nanoparticles, in particular with carbon nanotubes (CNTs). A complete, global modification of the polymer with nanoparticles leads to a change in the macro properties of the polymer. In particular, the polymer can become more brittle, which can lead to material failure in certain applications. U.S. Pat. No. 8,388,795 B2 and EP 2926987 A1 describe methods for producing a composite material in which two layers of a fibre material are joined by a nanoparticle-containing layer by positioning the layers relative to one another and then impregnating the fibre layers with matrix material. The described methods do not relate to multi-material composites with metal-polymer interfaces, and no solution is given as to how the tendency to crack at such interfaces can be counteracted.

US 2013/0108800 A1 discloses a method of forming a protective coating on substrates with layers containing nanoparticles. The protective coating improves the barrier properties so that the diffusion of liquids, solutes and/or gases into the substrate is inhibited and retarded. The protective coating may consist of a binder layer having a polymeric composition and a nanofiller layer or a plurality of alternating binder and nanofiller layers. Also, a gradient of the nanofillers may be present within the protective coating.

DE 196 13 645 A1 discloses a method for producing optical components with a gradient structure. Nanoscale particles dispersed in a liquid, curable matrix migrate within the matrix due to a potential difference and thus form a substance gradient, for example a refractive index gradient in optical lenses.

US 020100227141 A1 discloses a protective layer for industrial tools, for example matrices and a method for forming the protective layer. Such protective layers have a first protective layer and at least one further protective layer, wherein the first protective layer contains marker particles and the further layer cannot contain marker particles. Wear in the protective layer can thus be visually recognized, so that the protective layer can be renewed in a timely manner.

WO 2008 071312 A1 discloses a film, ribbon or sheet-like fabric in which a layer of a metal and/or a layer of a polymer are stacked alternatingly on top of one another, with at least one CNT layer. The production of the fabric is carried out by a rolling method. Again, no solution is given as to how the tendency to crack at the interfaces between the materials can be counteracted.

One approach to reducing the tendency of cracking in multi-material composites may be to smooth the sudden change in material properties at an interface between different materials and to gradually change the material properties in a layer at the interface.

CN 1510069 A discloses a method for producing a polymeric gradient material, e.g. a material made of polypropylene with PA-6 or polypropylene using talc, the gradient material being characterized by a locally gradually tiered concentration of materials. The material is produced by extrusion by charging the extruder with the starting materials in the desired, gradually tiered concentrations. WO 2011 039 009 A2 describes a method for producing a gradient layer by means of brush plating, in which very thin layers of nanoparticle-containing materials are applied to the starting material and the concentration of the nanoparticles is changed gradually from layer to layer. Both methods are very expensive.

The object of the invention is to propose, starting from the state of the art, a method for producing multi-material composites and a multi-material composite which overcome the disadvantages of the prior art and which prevent cracking and crack propagation due to different material properties in multi-material composites.

The object is achieved by a method having the features according to claim 1 and a multi-material composite having the features according to claim 9. Embodiments of the invention are specified in the dependent claims.

The method according to the invention is based on a gradual adaptation of the material properties of one of the materials to that of the other material at the interface between the materials of a multi-material composite while maintaining the macro properties of the materials.

The method according to the invention relates to the production of a multi-material composite having at least one metal layer and at least one fibre-reinforced or unreinforced first polymer layer. In the case of a fibre-reinforced version of the polymer layer, the polymer then acts as a matrix in which the fibres are embedded.

A second, likewise fibre-reinforced or unreinforced polymer layer which contains nanoparticles is arranged, at least in regions, between the metal layer and the first polymer layer. As a result of the nanoparticles, the second polymer layer has material properties which are more similar to the metal layer than the material properties of the first polymer layer without nanoparticles.

Under the influence of elevated temperature or elevated pressure and elevated temperature, a composite is formed from the three layers, wherein nanoparticles of the second polymer layer diffuse into the first polymer layer, so that a gradient layer is formed in which the nanoparticle concentration gradually decreases towards the first polymer layer. “Elevated” here is relative to standard conditions (101 325 Pa, 20° C.). However, it is clear to the person skilled in the art that the application of the parameters pressure and/or temperature must be such that a reduction of the viscosity of the polymeric material in the joining region is effected without the polymer decomposing.

Accordingly, a higher nanoparticle concentration is present in the gradient layer at the interface of the gradient layer to the metal layer than at the interface to the first polymer layer. The interface between the first polymer layer and the gradient layer, i.e. the beginning of the gradient layer, is that region in which nanoparticles are present for the first time. At the interface of the gradient layer to the metal layer, the nanoparticle concentration is only slightly less than or equal to the nanoparticle concentration in the second polymer layer prior to the application of pressure and/or temperature to form the composite.

By the “first polymer layer” it is meant a nanoparticle-free polymer layer. In this respect, the method consumes the regions of the first polymer layer adjoining the second polymer layer, since the gradient layer is formed from the second polymer layer and regions of the first polymer layer adjoining the second polymer layer in that nanoparticles diffuse from the second polymer layer into the first polymer layer.

“Nanoparticles” are understood to mean nanoscale fillers. Nanoparticles for adapting the material properties of the polymer of the second polymer layer to those of the metal are suitable for the method, for example by increasing the strength.

The method according to the invention smoothes the stepwise course of different material properties at the interface between the first polymer layer and the metal layer since in the gradient layer the material properties change gradually from metal-like to polymer-like in the direction of the first polymer layer. Advantageously, this reduces the tendency toward crack formation and crack propagation at the interfaces. The lifetime of the multi-material composite is increased.

In other words, by means of the method according to the invention, at least in regions, a gradual adaptation of polymeric material properties to metallic material properties occurs in the connection region of a multi-material composite comprising at least one metallic and at least one polymeric layer by local nanomodification of the polymeric material in the connection region. A global change in the polymeric material properties, i.e. a change over an extended, in particular the entire, volume range of the first polymer layer, does not take place according to the invention. The nanomodification of the polymeric material is limited spatially to the diffusion region of the nanoparticles at the connection between the metal layer and the polymer material and thus to the extent of the gradient layer.

The extent of the gradient layer is determined by the diffusion properties of the nanoparticles in the polymeric material and by the strength and duration of the application of the parameters of pressure and/or temperature, wherein the duration of the application is preferably between a few minutes and one to two hours. For a known polymeric material, the skilled person is readily able to determine how the application of the parameters of pressure and/or temperature has to be made in order to bring about the necessary reduction of the (dynamic) viscosity of the polymeric material in the joining area, without causing the polymer to decompose. The reduction in viscosity causes an increase in the diffusion coefficient. This causes nanoparticles to diffuse from the second to the first polymer layer. The extent of the gradient layer is preferably 10 μm to 1 mm, more preferably between 50 μm and 500 μm, most preferably between 100 μm and 300 μm.

The gradient of the nanoparticle concentration which forms as a function of temperature or of temperature and pressure can be determined, for example iteratively in the consolidated material, by means of a resistance measurement using the four-point probe technique. The measuring arrangement is to be chosen so that a sufficient evaluation of the graduated layer can take place. With an extent of the gradient layer of 100 μm, this corresponds to a lateral minimum resolution of 30 μm, for example. The change in resistance is a function of the nanoparticle content. For evaluation, planar FKV model systems having a known nanoparticle concentration are to be measured, from which a resistance-nanoparticle concentration curve can be determined. By correlating the measured resistances at the gradient layer with the resistance-nanoparticle concentration curve, it is possible to determine the local nanoparticle concentration and thus the progress of the graduation front as well as the local gradient.

The gradient of the nanoparticle concentration is stabilized by cooling and/or consolidation by a final curing of the composite. The way in which the gradient layer is stabilized is determined by the type of polymeric material of the gradient layer, it being clear to the person skilled in the art which method is to be selected.

The polymer layers may be fibre-reinforced or unreinforced. Preferably, at least the first polymer layer is fibre-reinforced, more preferably carbon fibre-reinforced.

In principle, all suitable fibres and semi-finished fibre products, for example rovings, nonwovens, mats, non-crimp fabrics, fabrics, braids, can be used for the method according to the invention as long as the free diffusion path of the nanoparticles is sufficiently large to form a gradient layer. It can be assumed that a fibre volume content of up to 60% certainly ensures a sufficient diffusion path. The method is in principle suitable for use with all suitable reinforcing fibre types, in particular carbon fibres.

The method can be applied to all metals and metallic alloys suitable for use in multi-material composites, e.g. steel, aluminium, titanium. The melting temperature of the metallic layer must be higher than the temperature to be used for forming the gradient layer and the composite respectively the curing temperature of the polymeric material.

The method is characterized by a particularly simple application. No changes are made in the production process of the metal layer and the first polymer layer. The production of the metal layer respectively the component that contains these layer and the production of the first polymer layer respectively the component that contains these layer can be done separately. The application of the second, nanoparticle-containing polymer layer, the formation of a composite and the generation of the gradient layer takes place subsequently by the thermal or mechanical-and-thermal joining process by means of a temperature increase or a pressure and temperature increase.

For example, the method according to the invention can comprise the following steps:
a. Providing a component comprising the metal layer;
b. Providing a component comprising the fibre-reinforced or unreinforced first polymer layer;
c. Partial or complete application of the second polymer layer onto the metal layer and/or onto the first polymer layer;
d. Positioning the components relative to each other so that the second polymer layer is at least partially arranged between the metal layer and the first polymer layer;
e. Heating or heating and applying pressure in a heating or heating-and-pressing tool, at least in the region where the second polymer layer is arranged between the metal layer and the first polymer layer to form a composite, wherein nanoparticles of the second polymer layer diffuse into the first polymer layer such that a gradient layer is formed in which the nanoparticle concentration decreases toward the first polymer layer;
f. Optionally finally curing the composite, cooling and removal from the heating or heating-and-pressing tool used in the step e.

The heating and the application of pressure preferably takes place locally limited to the connection region in which the second polymer layer is arranged between the metal layer and the first polymer layer.

The application of pressure to the composite can be done for example by means of an external, heatable tool, or intrinsically by a thermally induced volume change of the polymer, or by a combination of both options.

The heating of the connection region can take place via the local heating of the metal layer or via the local heating of the first polymer layer if said layer contains thermally conductive reinforcing fibres, or an external global heating of the composite can be carried out.

As polymers of the first and the second layer, thermoplastic polymers or special thermosetting polymers can be used.

In one embodiment of the method according to the invention, the polymer of the first and the second polymer layer is a thermoplastic polymer. Thermoplastic polymers are low viscosity and easily deformable in a certain temperature range between their melting respectively glass transition temperature and their decomposition temperature, wherein this state can be repeatedly achieved as many times as desired by cooling and reheating, as long as thermal decomposition of the material does not set in by overheating.

To carry out this embodiment of the method according to the invention, the first and the second polymer layer in the connection region are heated to a temperature above their melting respectively glass transition temperature and below their decomposition temperature. As a result, the thermoplastic material is converted into a low-viscosity state. “Low-viscosity” in the sense of the invention means that the viscosity is sufficiently low to form a gradient layer by diffusion of the nanoparticles from the second into the first polymer layer. The nanoparticles diffuse from the second polymer layer into the first polymer layer, and a composite comprising the gradient layer is formed. The stabilization of the gradient of the nanoparticle distribution and the solidification of the composite is effected by cooling the composite below the melt respectively glass transition temperature of the thermoplastic polymer.

In a further embodiment of the method according to the invention, the polymer of the first and the second polymer layer is a thermosetting polymer. In general, when in the fully cured state, thermosetting polymers can no longer be melted by the action of temperature. Many thermosetting polymers have multi-step consolidation functions (e.g. the A-state, B-state, C-state). With these thermosetting polymers, it is possible to achieve a low-viscosity material state at least once, under temperature and pressure, until the final, irreversible curing step (C-state). Particularly suitable for the method according to the invention are, firstly, Snapcure systems in which the final curing can be done very quickly. Furthermore, epoxy resins are particularly suitable, which are modified by the addition of additives so that the softening temperature of the resin is less than the crosslinking temperature, i.e. the temperature at which the curing reaction is triggered. These thermosetting resin systems are meltable and thus have processing properties similar to those of thermoplastic polymers.

To carry out the method according to the invention, a state of the thermosetting polymer of the first and the second polymer layer is induced by the application of elevated temperature or elevated temperature and pressure, the induced state having a lower viscosity than in the starting state. The nanoparticles diffuse from the second polymer layer into the first polymer layer, and a composite comprising the gradient layer is formed. The stabilization of the gradient of the nanoparticle distribution and the curing of the composite is achieved by final consolidation of the thermosetting polymer by further temperature or temperature and pressure increase.

In a further embodiment of the method according to the invention, the nanoparticles are carbon-based, such as graphene, graphene derivatives, carbon nanotubes (carbon nanotubes, CNT), derivatives thereof, carbon nanofibres (CNF) or combinations thereof. Particular preference is given to using CNT and/or graphene. Advantageously, the modification with carbon-based nanoparticles leads to a higher tensile and flexural strength, increased compression stability and/or improved stiffness compared to the unmodified polymeric material.

In a further embodiment of the method according to the invention, prior to the production of the multi-material composite, a pre-treatment of the surface of the metal layer is carried out at least in the region in which the second polymer layer is arranged between the metal layer and the first polymer layer, whereby the metal layer is provided with at least one adhesion-enhancing surface function, for example in the form of a microstructuring or a coating. This is done with the purpose of improving the adhesion between the metal layer and the second polymer layer. Options for enhancing adhesion are possible for example by mechanical or chemical pre-treatment of the metal layer, for example by blasting or by laser structuring or by coating the metal layer with a bonding agent in the joining region. The local modification of the metal layer in the joining region advantageously leads to particularly durable multi-material composites.

In a further embodiment of the method according to the invention, the second polymer layer is applied in liquid or solid state to the metal layer or the first polymer layer. The application of the second polymer layer is done as a prefabricated material and locally in the joining region of the multi-material composite. When the second polymer layer is applied, the nanoparticles are randomly distributed in the polymeric material. The gradient of the nanoparticle concentration is initiated in the further steps of the method under the influence of the parameters of pressure and/or temperature. Elaborate process steps for generating a gradient of the nanoparticle concentration during the production of the second polymer layer are not necessary according to the invention.

In a further embodiment of the method according to the invention, the second polymer layer is applied by spraying or dipping or coating or painting or inserting or a combination of two or more of these methods.

Inserting refers to an application of the second polymer layer in membrane form. The nanoparticles are present as particle fillers in a polymer matrix in these membranes, for example. Typically, the membranes can have thicknesses of 100 μm to 1 mm.

In a further embodiment of the method according to the invention, the formation of the composite takes place by hot pressing. The gradient layer also advantageously forms during the hot pressing process.

The object of the invention is further solved by a multi-material composite comprising at least a metal layer and a fibre-reinforced or unreinforced, first polymer layer and a gradient layer arranged at least partially between the metal layer and the first polymer layer. The gradient layer contains the polymer of the first polymer layer and nanoparticles. In the gradient layer, the nanoparticle concentration gradually decreases spatially from the metal layer to the first polymer layer. In the gradient layer of the multi-material composite according to the invention, therefore, there is a gradient of the nanoparticle concentration, wherein the nanoparticle concentration at the interface of the gradient layer to the metal layer is higher than at the interface to the first polymer layer. The interface between the first polymer layer and the gradient layer, respectively the beginning of the gradient layer, is that region in which nanoparticles are present for the first time.

Advantageously, the multi-material composite according to the invention is much less susceptible to the formation and propagation of cracks at the interface between the metallic and polymeric material and thus is particularly durable.

In one embodiment of the multi-material composite according to the invention, the polymer of the first polymer layer and the gradient layer is a thermoplastic polymer.

In another embodiment of the multi-material composite according to the invention, the polymer of the first polymer layer and the gradient layer is a thermosetting polymer.

In a further embodiment of the multi-material composite according to the invention, the nanoparticles contained in the gradient layer are carbon-based. Preferably, the nanoparticles are selected from graphene, graphene derivatives, carbon nanotubes (CNTs), derivatives thereof, carbon nanofibres (CNF), or combinations thereof. Particular preference is given to using CNT and/or graphene. Advantageously, the modification with carbon-based nanoparticles leads, for example, to an increased tensile and flexural strength, increased compression stability and/or improved stiffness compared to the unmodified polymeric material.

In a further embodiment of the multi-material composite according to the invention, the metal layer has an adhesion-enhancing surface at least in the region in which the gradient layer is arranged between the metal layer and the first polymer layer. The surface may have, for example, a microstructuring or an adhesion-promoting coating. Advantageously, the adhesion-enhancing modification of the metal surface in the joining region leads to particularly durable multi-material composites.

The invention is not limited to the represented and described embodiments, but also comprises all embodiments which have the same effect for the purpose of the invention. Furthermore, the invention is also not limited to the feature combinations specifically described, but may also be defined by any other combination of specific features of any of the individual features disclosed as a whole, provided that the individual features are not mutually exclusive or that a specific combination of individual features is not explicitly excluded.

In the following, the invention will be explained by means of exemplary embodiments with reference to schematic figures which are not true to scale, without being limited to said figures, in which:

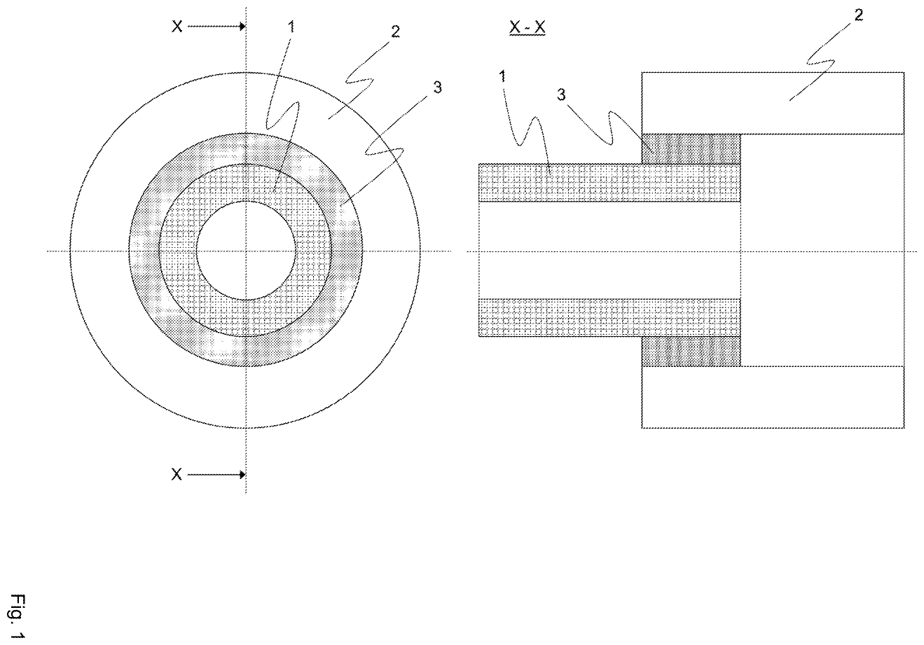

FIG. 1 shows two sectional views of the front and the side view, taken along the line X-X of an arrangement of components for producing a rotationally-symmetric multi-material composite, and

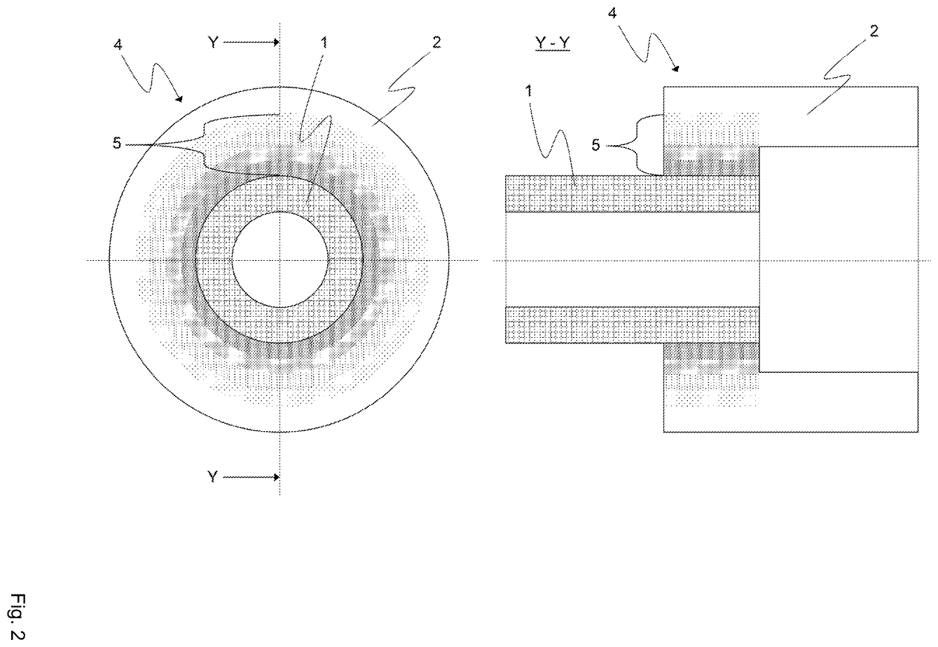

FIG. 2 shows two sectional views of the front and the side view, taken along the line Y-Y of a rotationally-symmetric multi-material composite producible from the arrangement of FIG. 1.

In FIG. 1, an exemplary embodiment of an arrangement of components for producing a rotationally symmetric multi-material composite is shown, which can serve as a starting point for the method according to the invention. Between a rotationally-symmetric metallic component 1 and a rotationally-symmetric component 2 consisting of a fibre-reinforced plastic, a layer 3 is arranged in the connecting region of the two components 1 and 2, the layer containing the same plastic as the component 2, said plastic of layer 3 being reinforced with nanoparticles. The components 1, 2, and 3 are each manufactured separately. Layer 3 can be present in membrane form and placed on the surface of metallic component 1 before component 2 is positioned relative to component 1 and layer 3 in the arrangement shown in FIG. 1, for example. For example, the formation of a gradient layer (not shown) takes place by hot pressing in the region of the arrangement in which layer 3 is arranged between components 1 and 2.

FIG. 2 shows an exemplary embodiment of a multi-material composite 4 according to the invention, said composite being producible by means of the method according to the invention from an arrangement such as that shown in FIG. 1, for example. A gradient layer 5 is arranged between the metallic component 1 and the component made of fibre-reinforced plastic 2. In the formation of the multi-material composite 4 and the gradient layer 5, nanoparticles diffuse into the plastic of component 2 so that the radial extent of the gradient layer is greater than the radial extent of layer 3 shown in FIG. 1. In the gradient layer, the concentration of nanoparticles decreases radially outwards, i.e. towards component 2.

The invention is not limited to rotationally-symmetric arrangements, but can be applied to any geometry suitable for joining a multi-material composite.

### REFERENCE SIGNS

1 Component made of a metal
2 Component made of a fibre-reinforced plastic
3 Nanoparticle-reinforced plastic layer
4 Multi-material composite
5 Gradient layer

1. A method for producing a multi-material composite, wherein a composite is formed from at least one metal layer, at least one fibre-reinforced or unreinforced first polymer layer and at least one fibre-reinforced or unreinforced second polymer layer formed from the polymer of the first polymer layer and nanoparticles, said second polymer layer being at least partially arranged between the metal layer and the first polymer layer, under the influence of elevated temperature or elevated temperature and elevated pressure, wherein nanoparticles of the second polymer layer diffuse into the first polymer layer so that a gradient layer is formed in which the nanoparticle concentration decreases toward the first polymer layer.

2. The method according to claim 1, wherein the polymer of the first polymer layer and of the second polymer layer is a thermoplastic polymer.

3. The method according to claim 1, wherein the polymer of the first polymer layer and of the second polymer layer is a thermosetting polymer having a multi-stage consolidation function.

4. The method according to claim 1, wherein the nanoparticles of the second polymer layer are carbon-based.

5. The method according to claim 1, wherein at least in the region in which the second polymer layer is arranged between the metal layer and the first polymer layer, a pre-treatment of the metal layer is carried out, whereby the metal layer is provided with at least one adhesion-enhancing surface function.

6. The method according to claim 1, wherein the second polymer layer is applied in a liquid or solid state to the metal layer or to the first polymer layer.

7. The method according to claim 1, wherein the second polymer layer is applied by spraying or dipping or coating or painting or inserting or a combination of two or more of these methods.

8. The method according to claim 1, wherein formation of the composite is carried out by hot pressing.

9. A multi-material composite comprising at least one metal layer and at least one fibre-reinforced or unreinforced first polymer layer, wherein a gradient layer containing the polymer of the first polymer layer and nanoparticles is arranged at least partially between the metal layer and the first polymer layer, the nanoparticle concentration gradually decreasing spatially from the metal layer to the first polymer layer in said gradient layer.

10. The multi-material composite according to claim 9, wherein the polymer is a thermoplastic polymer.

11. The multi-material composite according to claim 9, wherein the polymer is a thermosetting polymer.

12. The multi-material composite according to claim 9, wherein the nanoparticles are carbon-based.

13. The multi-material composite according to claim 9, wherein the metal layer has an adhesion-enhancing surface at least in the region in which the gradient layer is arranged between the metal layer and the first polymer layer.

14. The method according to claim 2, wherein the nanoparticles of the second polymer layer are carbon-based.

15. The method according to claim 3, wherein the nanoparticles of the second polymer layer are carbon-based.

16. The method according to claim 14, wherein at least in the region in which the second polymer layer is arranged between the metal layer and the first polymer layer, a pre-treatment of the metal layer is carried out, whereby the metal layer is provided with at least one adhesion-enhancing surface function.

17. The method according to claim 15, wherein at least in the region in which the second polymer layer is arranged between the metal layer and the first polymer layer, a pre-treatment of the metal layer is carried out, whereby the metal layer is provided with at least one adhesion-enhancing surface function.

18. The method according to claim 1, wherein:
the nanoparticles of the second polymer layer are carbon-based;
at least in the region in which the second polymer layer is arranged between the metal layer and the first polymer layer, a pre-treatment of the metal layer is carried out, whereby the metal layer is provided with at least one adhesion-enhancing surface function;
the second polymer layer is applied in a liquid or solid state to the metal layer or to the first polymer layer;
the second polymer layer is applied by spraying or dipping or coating or painting or inserting or a combination of two or more of these methods; and
formation of the composite is carried out by hot pressing.

19. The multi-material composite according to claim 12, wherein the metal layer has an adhesion-enhancing surface at least in the region in which the gradient layer is arranged between the metal layer and the first polymer layer.

20. The multi-material composite according to claim 19, wherein the polymer is a thermoplastic polymer or a thermosetting polymer.
